(19) United States
(12) Patent Application Publication
(10) Pub. No.: US 2011/0274120 A1
(43) Pub. Date: Nov. 10, 2011

(54) NETWORK DATA PACKET FRAMENTATION AND REASSEMBLY METHOD

(75) Inventors: Anh T. Dang, Austin, TX (US); James R. Gallagher, Austin, TX (US); Binh K. Hua, Austin, TX (US); Hong L. Hua, Austin, TX (US)

(73) Assignee: International Business Machines Corporation, Armonk, NY (US)

(21) Appl. No.: 12/774,834

(22) Filed: May 6, 2010

(51) Int. Cl. H04J 3/24

(52) U.S. Cl. 370/474

(57) ABSTRACT

The method determines whether a particular jumbo data packet benefits from fragmentation and reassembly management during communication through a network or networks. The method determines the best communication path, including path partners, between a sending information handling system (IHS) and a receiving IHS for the jumbo packet. A packet manager determines the maximum transmission unit (MTU) size for each path partner or switch in the communication path including the sending and receiving IHSs. The method provides transfer of the jumbo packets intact between those path partner switches of the communication path exhibiting MTU sized for jumbo or larger packet transfer. The method provides fragmentation of jumbo packets into multiple normal packets for transfer between switches exhibiting normal packet MTU sizes. The packet manager reassembles multiple normal packets back into jumbo packets for those network devices, including the receiving IHS, capable of managing jumbo packets.

### BACKGROUND

The disclosures herein relate generally to information handling systems (IHSs), and more specifically, to management of data packet communications in an IHS or network.

A network may include multiple server information handling systems (IHSs), client IHSs, switches, or other network devices for processing, handling, communicating or otherwise manipulating network information. For example, multiple client IHSs may connect to a server IHS over a network that provides communications and other data management in a small business environment. Server IHSs deliver information and software to other client IHSs that link through a network that may include switches, routers, gateways, hubs and other network devices. Server IHSs may communicate with other server IHSs or client IHSs by using data packets or frames, such as Ethernet packets. When employing a multitasking operating system, a single server IHS may manage multiple programs and thus handle multiple server functions such as Internet communication, database management, email handling, and other server functions simultaneously. IHSs, such as server IHSs may send communication data requests in the form of frames or data packets to one or more IHSs, such as client IHSs. Ethernet data packets or frames provide a standard data format for data transmissions from network device to network device in a network.

Data packets may exhibit different memory size or data packet sizes. Each device of a network may exhibit a different data packet size management capacity. For example, a particular network device may exhibit a limitation of data packet size at the input or output port of that network device. Different network devices of a network may employ different data packet sizes. In this case, data packet size conversion between network devices may play an important role in efficient data packet communications. One method of data packet size conversion includes data packet fragmentation and reassembly.

### BRIEF SUMMARY

In one embodiment, a data packet fragmentation and reassembly method is disclosed that includes generating, by a first information handling system (IHS), a jumbo information packet for transmission to a second IHS via a plurality of network devices in a communication path between the first and second IHSs, the first and second IHSs employing jumbo information packets as a maximum transmission unit (MTU) size thereof, each of the plurality of network devices exhibiting a respective MTU size. The method also includes fragmenting, by a first jumbo MTU size network device of the plurality of network devices, the jumbo information packet into multiple normal information packets if the MTU size decreases between the first jumbo MTU size network device and a second network device downstream of the first jumbo MTU size network device in the communication path. The method further includes reassembling, by a third network device downstream of the second network device, the multiple normal information packets into a jumbo information packet if the MTU size of the third downstream network device and a fourth network device downstream of the third network device both accommodate a jumbo information packet, thus providing a reassembled jumbo information packet.

In another embodiment, a communication system is disclosed that includes a first information handling system (IHS). The communication system also includes a second IHS coupled to the first IHS by a plurality of network devices that form a communication path between the first IHS and the second IHS. The first IHS generates a jumbo information packet for transmission to the second IHS via the plurality of network devices in the communication path between the first and second IHSs, the first and second IHSs employing jumbo information packets as a maximum transmission unit (MTU) size thereof, each of the plurality of network devices exhibiting a respective MTU size. The communication path includes a first jumbo MTU size network device that fragments the jumbo information packet into multiple normal information packets if the MTU size decreases between the first jumbo MTU size network device and a second network device downstream of the first jumbo MTU size network device in the communication path. The communication path further includes a third network device downstream of the second network device that reassembles the multiple normal information packets into a jumbo information packet if the MTU size of the third downstream network device and a fourth network device downstream of the third network device both accommodate a jumbo information packet, thus providing a reassembled jumbo information packet.

In yet another embodiment, a computer program product is disclosed. The computer program product includes a computer readable storage medium for use on a first information handling system (IHS), a second IHS and a plurality of network devices that form a communication path between the first IHS and the second IHS. The computer program product includes first instructions that generate a jumbo information packet for transmission to the second IHS via the plurality of network devices in the communication path between the first and second IHSS, the first and second IHSS employing jumbo information packets as a maximum transmission unit (MTU) size thereof, each of the plurality of network devices exhibiting a respective MTU size. The computer program product also includes second instructions that instruct a first jumbo MTU size network device in the communication path to fragment the jumbo information packet into multiple normal information packets if the MTU size decreases between the first jumbo MTU size network device and a second network device downstream of the first jumbo MTU size network device in the communication path. The computer program product further includes third instructions that instruct a third network device downstream of the second network device in the communication path to reassemble the multiple normal information packets into a jumbo information packet if the MTU size of the third downstream network device and a fourth network device downstream of the third network device both accommodate a jumbo information packet, thus providing a reassembled jumbo information packet. The first, second and third instructions are stored on the computer readable storage medium.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of a representative information handling system (IHS) that employs the disclosed packet fragmentation and reassembly methodology.

FIG. 2 is a block diagram of a network including network devices that employ the disclosed packet fragmentation and reassembly methodology.

FIG. 3 is a flowchart of an embodiment of the disclosed packet fragmentation and reassembly methodology that manages jumbo packet transfer from one network IHS to another network IHS.

FIG. 4 is a flowchart of another embodiment of the disclosed packet fragmentation and reassembly methodology that manages jumbo packet transfer from one network IHS to another network IHS.

### DETAILED DESCRIPTION

Information handling systems (IHSs) typically employ operating systems that execute applications which communicate with other IHSs of a network. For example, in an Ethernet network, network devices communicate by using network data packets or frames, such as Ethernet packets or other packet types. In one embodiment, a “normal packet” is a normal information packet exhibiting a 1500 byte data packet payload. A “jumbo packet” or jumbo information packet may include up to 9000 bytes of payload. While the terms jumbo information packet or jumbo packet and normal information packet or normal packet exhibit MTU sizes of 9000 bytes and 1500 bytes respectively in the disclosed embodiment, it should be understood that these terms may apply to different MTU sizes as well provided the jumbo packet is larger than the normal packet.

A sending IHS, such as a server IHS, may communicate over a network with a receiving IHS, such as a client IHS, using normal packets and jumbo packets. Those packets may transmit in both directions between server and client IHSs over a communication path between these IHSs. The sending IHS links to the receiving IHS through network devices, such as switches, hubs, gateways, routers, or other network devices in the communication path. The sending IHS, sends a data packet through each network device in a communication path or link to the receiving IHS. Each network device in the communication path, including the sending and receiving IHSs has a maximum allowable data packet size. The maximum allowable transmission unit (MTU) represents that maximum allowable data packet size. For example, a particular IHS may exhibit an MTU of 1500 bytes. In that case, the particular IHS may not communicate using data packets that are greater in size than 1500 bytes, or normal packet size. If the particular IHS exhibits an MTU of 9000 bytes, that particular IHS may communicate with other network devices using jumbo packets.

Each network device communicates with a consecutive, adjacent, next or neighboring network device, such as a path partner, along the communication path between the sending and receiving IHSS. Neighboring network devices communicate by using the network device ports between these neighboring network devices. The term “neighboring network” device does not necessarily mean that two network devices are in close proximity to one another, but rather that one of these network devices is immediately downstream from the other network device. Each sending network device along the communication path sends or outputs a data packet to a receiving network device or input path partner in the communication path. In one embodiment of the disclosed packet fragmentation and reassembly methodology, network devices may exhibit different MTU sizes. For example, one network device may exhibit an MTU size of 9000 bytes thus allowing jumbo data packet transfers in one communication cycle. However another network device may exhibit an MTU of 1500 bytes and allow only normal data packet transfers. A network device input or output port provides a way to determine the MTU size of that device. For example, if the input and/or output port of a network device manages no greater than 1500 byte data transfers, that network device has an MTU size of 1500 bytes.

When one network device in the communication path between a sending network device and a receiving network device exhibits a normal data packet size, the network may limit all data packet transfer along the communication path to normal data packet size only. More specifically, this may be the case wherein the communication path includes one or more network devices exhibiting a normal MTU size of 1500 bytes while the sending and receiving network devices each exhibit a jumbo MTU size of 9000 bytes. In that case, if the sending IHS wants to send a jumbo packet to a receiving IHS, the sending IHS will first fragment the jumbo packet into a group of multiple normal packets and send each normal packet one at a time until the receiving IHS receives all normal packets. The receiving IHS then reassembles the normal packets back into the original jumbo packet. In this manner of fragmenting and reassembling data packets, the receiving IHS receives the jumbo packet from the sending IHS. Unfortunately, this approach results in significant network overhead spent on dedicating network resources for data packet fragmentation, reassembly and transmission. This is true even if two or more neighboring or communication path partner network devices have a higher MTU size, such an MTU of 9000 bytes. The entire communication path effectively switches to normal packet size which acts as the lowest common denominator packet size for the multiple network devices in the communication path.

In one embodiment of the disclosed packet fragmentation and reassembly methodology, a sending network device sends a data packet to a receiving network device via a communication path that includes multiple other network devices. Some network devices in the communication path may exhibit one MTU size (e.g. a jumbo size), while other network devices may exhibit another MTU size (e.g. a normal size). The disclosed methodology identifies those consecutive network devices in a network communication path between a sending IHS and a receiving IHS that may benefit from larger data packet transmission size. More specifically, if two consecutive network devices in the communication path exhibit a jumbo MTU size, then the first consecutive network device reassembles the normal sized packets that it receives into jumbo packets before transmitting packets to the second consecutive network device. This may achieve an overall performance improvement in network data packet transmission efficiency along the communication path between the sending network device and the receiving network device.

In another embodiment, the disclosed methodology employs a packet manager to provide operating system level analysis to determine best data packet transmission sizes for data packets between consecutive or path partner network devices in the communication path between a sending network device and a receiving network device.

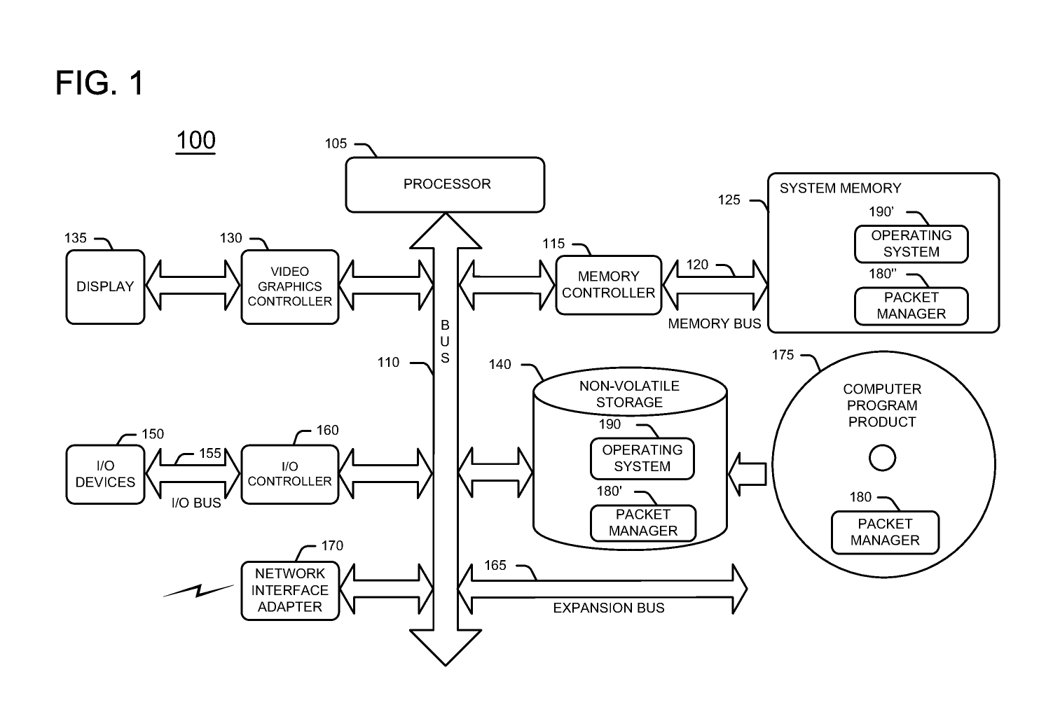

FIG. 1 shows an information handling system 100 with a network data packet manager 180 to practice the disclosed packet fragmentation and reassembly methodology. IHS 100 includes a processor 105 that may include multiple cores. IHS 100 processes, transfers, communicates, modifies, stores or otherwise handles information in digital form, analog form or other form. IHS 100 includes a bus 110 that couples processor 105 to system memory 125 via a memory controller 115 and memory bus 120. In one embodiment, system memory 125 is external to processor 105. System memory 125 may be a static random access memory (SRAM) array or a dynamic random access memory (DRAM) array. Processor 105 may also include local memory (not shown) such as L1 and L2 caches (not shown). A video graphics controller 130 couples display 135 to bus 110. Nonvolatile storage 140, such as a hard disk drive, CD drive, DVD drive, or other nonvolatile storage couples to bus 110 to provide IHS 100 with permanent storage of information. I/O devices 150, such as a keyboard and a mouse pointing device, couple to bus 110 via I/O controller 160 and I/O bus 155.

One or more expansion busses 165, such as USB, IEEE 1394 bus, ATA, SATA, PCI, PCIE, DVI, HDMI and other busses, couple to bus 110 to facilitate the connection of peripherals and devices to IHS 100. A network interface adapter 170 couples to bus 110 to enable IHS 100 to connect by wire or wirelessly to a network and other information handling systems. In this embodiment, network interface adapter 170 may also be called a network communication adapter or a network adapter. While FIG. 1 shows one IHS that employs processor 105, the IHS may take many forms. For example, IHS 100 may take the form of a desktop, server, portable, laptop, notebook, or other form factor computer or data processing system. IHS 100 may take other form factors such as a gaming device, a personal digital assistant (PDA), a portable telephone device, a communication device or other devices that include a processor and memory.

IHS 100 employs an operating system (OS) 190 that may store on nonvolatile storage 145. IHS 100 includes a packet manager 180 computer program product on digital media 175 such as a CD, DVD or other media. In one embodiment, a designer or other entity configures the computer program product with packet manager 180 software to practice the disclosed packet fragmentation and reassembly methodology. In practice, IHS 100 may store packet manager 180 and OS on nonvolatile storage 145 as packet manager 180′ and OS 190. When IHS 100 initializes, the IHS loads packet manager 180′ and OS 190 into system memory 125 for execution as packet manager 180″ and OS 190′, respectively.

As will be appreciated by one skilled in the art, aspects of the disclosed process status determination methodology may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product, such as computer program product 175 embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

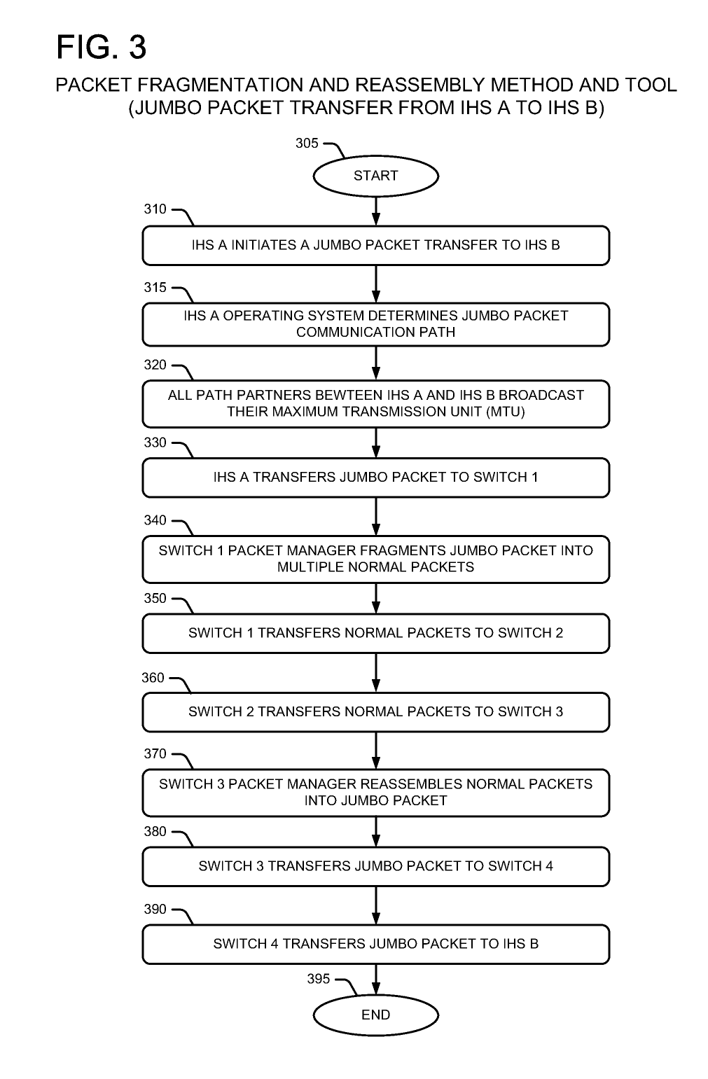

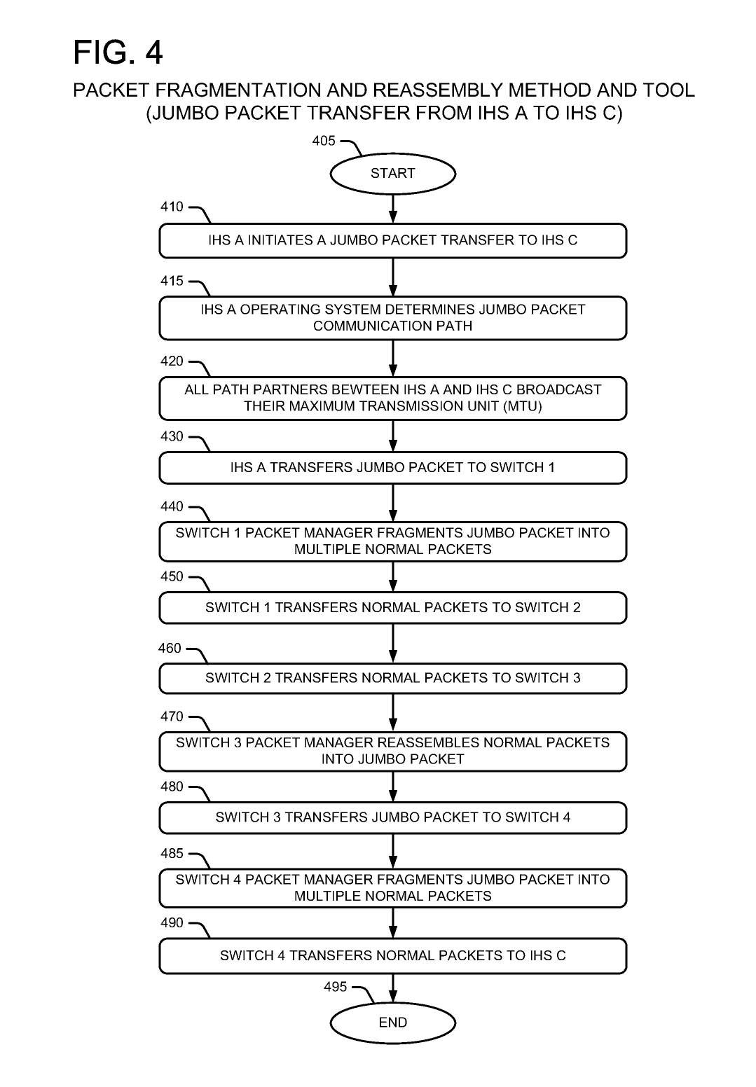

Aspects of the present invention are described below with reference to flowchart illustrations and/or block diagrams of methods, apparatus (systems) and computer program products according to embodiments of the invention. It will be understood that each block of the FIG. 3 and FIG. 4 flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts of FIG. 3 and FIG. 4 and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowcharts of FIG. 3 and FIG. 4 described below.

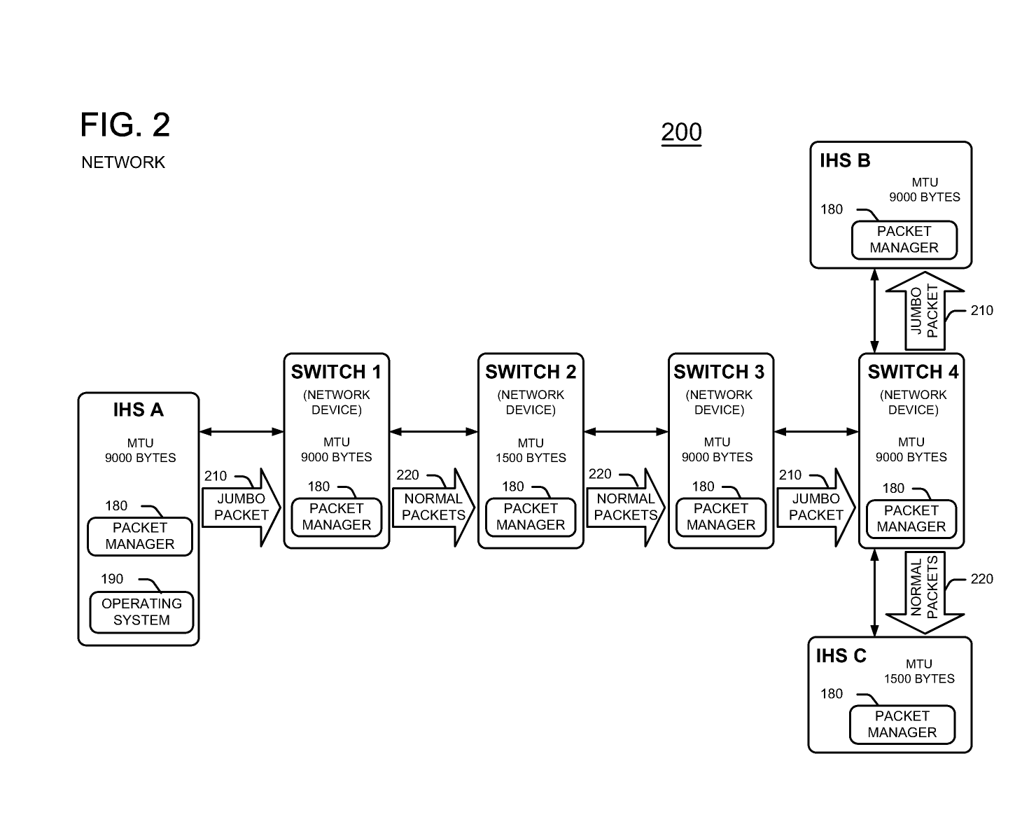

FIG. 2 is a block diagram representation of a network 200 that a designer or other entity configures with packet manager 180 software according to the disclosed packet fragmentation and reassembly methodology. Network 200 includes an IHS A that couples to a switch 1 network device. For discussion purposes, IHS A is the sending IHS and IHS B and IHS C are receiving IHSs. It should be understood that in one embodiment the roles of IHS A and IHS B are reversible, and that in another embodiment the roles of IHS A and IHS C are reversible. Switch 1 is an example of another IHS executing in network 200 that includes packet manager 180 software. During network 200 operation, packet manager 180 operates within switch 1 to provide functionality to implement the disclosed packet fragmentation and reassembly methodology as described in more detail below. Switch 1 includes operating system (OS) 190 to provide network operations capability for multiple functions of switch 1. Switch 1 couples to a switch 2 that includes a copy of packet manager 180. Switch 2 couples to a switch 3 that includes a copy of packet manager 180. Switch 3 couples to a switch 4 that includes a copy of packet manager 180. Switch 4 couples to an IHS B and also to an IHS C that each include a copy of packet manager 180 software. Switches 1, 2, 3 and 4 are network devices that in practice may be hubs, routers, gateways as well as other types of IHSs.

Each network device of network 200, namely IHS A, switch 1, switch 2, switch 3, switch 4, IHS B, and IHS C exhibit a particular MTU size per device. For example, IHS A exhibits an MTU size of 9000 bytes. In other words, IHS A is capable of processing 9000 byte or smaller data packets as input or output. Switch 1 also exhibits an MTU size of 9000 bytes. Switch 2 exhibits an MTU size of 1500 bytes and includes the capability of managing normal packets as input or output. Switch 3 and switch 4 each exhibit MTU sizes of 9000 bytes. IHS B exhibits an MTU size of 9000 bytes, and IHS C exhibits an MTU size of 1500 bytes. Each network device of network 200 that couples to another network device of network 200 is a path partner provided one of the two network devices is immediately downstream from the other. For example, IHS A is a path partner to switch 1, switch 1 is a path partner to switch 2, switch 2 is path partner to switch 3. Switch 3 is a path partner to switch 4 and switch 4 is a path partner to both IHS B and IHS C. A communication path in network 200 exhibits a linking of path partners from a sending network device such as IHS A to a receiving network device such as IHS B or IHS C. In the above scenario, switches 1, 2, 3 and 4 form a communication path between IHS A and IHS B. Switches 1, 2, 3 and 4 also form a communication path between IHS A and IHS C.

In the case wherein IHS A sends or transmits a particular data packet from IHS A to IHS B, each network device in a communication data path between IHS A and IHS B is responsible for passing, transmitting, or otherwise managing the communication transfer of that particular data packet from one path partner network device or switch to another path partner network device or switch. For example, IHS A may transmit a particular data packet to IHS B through switch 1, switch 2, switch 3, and switch 4. In that case, switch 1 is a consecutive network device, neighbor, or path partner to IHS A. Switch 2 is a consecutive network device, consecutive switch, or path partner to switch 1. Switch 3 is a consecutive switch or path partner to switch 2. Switch 4 is a consecutive switch or path partner to switch 3. And finally, IHS B is a consecutive network device and path partner to switch 4 along the particular data communication path from IHS A to IHS B. In this scenario wherein IHS A is the sending network device and IHS B is the receiving network device, switch 1 is downstream of IHS A, switch 2 is downstream of switch 1, switch 3 is downstream of switch 2, switch 4 is downstream of switch 3 and IHS B is downstream of switch 4.

As described in more detail below, a sending IHS, such as IHS A may seek to transmit a jumbo data packet or jumbo information packet, such as a jumbo packet 210 to another IHS or receiving IHS of network 200. Before IHS A transmits jumbo packet 210, IHS A first establishes a data path or communication path between the sending IHS and receiving IHS. In the case wherein the sending IHS sends jumbo packet 210, network device neighbors that share an MTU size of 9000 bytes may transmit jumbo packet 210 as a single transmit of 9000 bytes instead of multiple transmits of a smaller data packet size. A typical smaller data packet is a normal data packet or normal information packet (normal packet) of 1500 bytes. Normal packets 220 include the group of normal packets that together form and provide all of the information of jumbo packet 210.

As shown in FIG. 2, IHS A may transfer or otherwise communicate using a jumbo packet 210 from IHS A to consecutive switch 1. Switch 1 and IHS A are path partner network devices and also consecutive network devices with switch 1 being downstream from IHS A in the communication path. Switch 1 may transfer normal packets 220 that include the information of jumbo packet 210 in more than one normal packet to switch 2. Switch 2 may transfer normal packets 220 to switch 3 and switch 3 may transfer a jumbo packet 210 to switch 4. Switch 4 may transfer jumbo packet 210 directly to a receiving IHS B. However, switch 4 may employ a transfer of multiple normal packets 220 to transfer the total information of jumbo packet 210 to receiving IHS C. Data packet fragmenting or fragmentation involves converting jumbo packet 210 into normal packets 220 and provides one aspect of the disclosed packet fragmentation and reassembly methodology. Data packet reassembly or reassembling involves converting multiple normal packets 220 back into a reassembled jumbo information packet, such as jumbo packet 210, and provides another aspect of the disclosed packet fragmentation and reassembly methodology.

Packet manager 180 software that may reside within each network device of network 200, is responsible for data packet fragmentation and reassembly. Packet manager 180 determines the fragmentation and reassembly requirements of a data packet transfer along the communication path of network 200 prior to the initiation of that data packet transfer. Packet manager 180 determines packet sizing from MTU data that each network device provides. As described below, network devices of network 200 may broadcast or otherwise provide their individual MTU sizes to an originating or sending IHS prior to initial transfer of a data packet, such as jumbo packet 210.

IHS A is a sending network device that employs or executes packet manager 180 to implement the disclosed packet fragmentation and reassembly methodology. Each network device of network 200 may include the same packet manager 180 software. Network 200 depicts one example of a network that employs the disclosed packet fragmentation and reassembly methodology to increase overall network transmission efficiency. Other embodiments may exhibit more or fewer network devices in a variety of topologies and forms not shown in the communication path, but still within the teachings herein. The disclosed packet fragmentation and reassembly methodology may function across multiple networks and multiple communication paths of different architectures and designs.

If two consecutive network devices in the network path exhibit a jumbo MTU size, then the upstream network device may repackage the multiple normal packets that it receives into a jumbo packet and send the repackaged jumbo packet to the downstream network device for handling. This may increase overall network efficiency. More particularly, if two network devices such as switch 3 and switch 4 exhibit the same jumbo MTU size, such as 9000 bytes which in this example they do so exhibit, then the upstream network device (switch 3) may repackage the multiple normal packets that it receives into a jumbo packet. Switch 3 then sends the reassembled jumbo network packet to switch 4 that also exhibits an MTU size of 9000 bytes. This repackaging results in an overall increase in network transmission efficiency of data packets.

The flowcharts of FIG. 3 and FIG. 4 illustrate the architecture, functionality, and operation of possible implementations of systems, methods and computer program products that perform packet management in accordance with multiple embodiments of the present invention. In this regard, each block in the flowchart of FIG. 3 and FIG. 4 may represent a module, segment, or portion of code, that comprises one or more executable instructions for implementing the specified logical function(s). It should also be noted that, in some alternative implementations, the functions noted in the block may occur out of the order noted in FIG. 3 or FIG. 4. For example, two blocks shown in succession may, in fact, be executed substantially concurrently, or the blocks may sometimes be executed in the reverse order, depending upon the functionality involved. It will also be noted that each block of FIG. 4 and combinations of blocks in the block diagrams and/or flowchart illustration, can be implemented by special purpose hardware-based systems that perform the specified functions or acts, or combinations of special purpose hardware and computer instructions.

FIG. 3 is a flowchart that shows process flow in an embodiment of the disclosed methodology that provides data packet fragmentation and reassembly. More specifically, the flowchart of FIG. 3 shows how the embedded packet manager 180 of FIG. 1 and FIG. 2 tests to determine the opportunity for jumbo packet transfer between adjacent, neighboring, path partner, or consecutive network devices. Packet manager 180 may provide network devices with jumbo packet or larger data packet transfer sizes between those network devices capable of handling jumbo packets, such as 9000 bytes in size. Jumbo packet transfers may include fragmenting the particular jumbo packet, such as jumbo packet 210 into multiple normal packets, such as normal packets 220 and reassembling normal packets 220 back into jumbo packet 210, as well as other features as described below. The disclosed packet fragmentation and reassembly method starts, as per block 305.

In one embodiment, IHS A initiates a jumbo packet transfer to IHS B, as per block 310. In other words, a sending IHS, namely IHS A generates, or otherwise provides a 9000 byte data packet for transfer or communication through a communication path of network 200 to a receiving IHS, namely IHS B. In order to transfer jumbo packet 210 from IHS A to IHS B, IHS A determines a path for that communication transfer. In actual practice, operating system 190 of IHS A determines a communication path for jumbo packet 210, as per block 315. For example, IHS A may determine that the most efficient use of network 200 resources is a communication path for IHS A to IHS B through switches 1, 2, 3, and 4. In other words, operating system 190 determines the best communication path for jumbo packet 210 transfer from IHS A to IHS B as being from IHS A to switch 1, switch 1 to switch 2, switch 2 to switch 3, switch 3 to switch 4, and switch 4 to IHS B. IHS A may rely on other software (not shown), such as that of the other network devices of network 200 to provide information relevant to generating communication path choices.

In the disclosed embodiment, each communication path partner between IHS A and IHS B broadcasts its respective MTU size, as per block 320. In this manner, IHS A may interpret the data packet size constraints for each path partner or member of the communication path from IHS A to IHS B. To initiate data packet transfer, IHS A transfers jumbo packet 210 to switch 1, as per block 330. Since both IHS A and switch 1 exhibit an MTU of 9000 bytes, jumbo packet 210 may transfer between these communication path partners, namely IHS A and switch 1, intact as a full jumbo packet. In other embodiments, network 200 may not provide the ability to provide multiple data packet transfer sizes between path partners of the communication path of two consecutive path partners that do not exhibit the same MTU size. In that case, IHS A may first reduce jumbo packet 210 to multiple normal packets 220 and transfer those packets in succession across the communication path. Jumbo packet transfers provide a more efficient means of transfer of data between network devices of network 200 than do normal packets.

Switch 1 packet manager 180 fragments jumbo packet 210 into multiple normal packets 220, as per block 340, because switch 2 cannot handle jumbo packets. Because the next or downstream path partner in the communication path for switch 1, namely switch 2 exhibits an MTU size of 1500 bytes, packet manager 180 of switch 1 determines that the transfer of jumbo packet 210 requires a reduction or fragmentation in size into multiple normal packets 220 of 1500 bytes or less. In this manner, information of jumbo packet 210 is safe in the form of normal packets 220 during transfer along the communication path. Switch 1 transfers normal packets 220 to switch 2, as per block 350. In other words, switch 1 transmits the information of jumbo packet 210 in the form of multiple normal packets, namely normal packets 220, to switch 2. Switch 2 transfers normal packets 220 to switch 3, as per block 360. Although switch 3 has an MTU of 9000 bytes, during the transfer from switch 2 to switch 3, packet manager 180 of switch 2 constrains the transfer size to the lowest MTU of both switch 2 and switch 3, namely 1500 bytes. In this example, because switch 2 exhibits an MTU of 1500 bytes, the transfer from switch 2 includes multiple normal data packet transfers, such as those of normal packets 220.

Switch 3 packet manager 180 reassembles the multiple normal packets of normal packets 220 into jumbo packet 210, as per block 370. Switch 3 packet manager 180 desires a transfer to path partner switch 4 a jumbo packet size. In this manner, network 200 provides a reduction in total data packet transfers along the communication path between IHS A and IHS B. Switch 3 transfers jumbo packet 210 to switch 4, as per block 380. Switch 4 transfers jumbo packet 210 to IHS B, as per block 390. Although data packet transfer resources may continue as long as network 200 is active, for this embodiment, the disclosed packet fragmentation and reassembly methodology ends, as per block 395. In the above described process flow, consecutive network devices such as switch 3 and switch 4 that each exhibit the same jumbo packet size may communicate with one another using jumbo size packets even though other network devices in the communication path exhibit a smaller size than jumbo size.

FIG. 4 is a flowchart that depicts process flow in another embodiment of the disclosed methodology that provides data packet fragmentation and reassembly. More specifically, the flowchart of FIG. 4 shows how the embedded packet manager 180 of FIG. 1 and FIG. 2 tests to determine the opportunity for jumbo packet transfer between adjacent, neighboring, path partner, or consecutive network devices. Packet manager 180 may provide network devices with jumbo packet transfer sizes between those consecutive network devices capable of handling jumbo packets, such as 9000 bytes in size. Jumbo packet transfers may include fragmenting the particular jumbo packet, such as jumbo packet 210 into multiple normal packets, such as those of normal packets 220 and reassembling normal packets 220 back into jumbo packet 210, as well as other features as described below. The disclosed packet fragmentation and reassembly method starts, as per block 405.

In one embodiment, IHS A initiates a jumbo packet transfer to IHS C, as per block 410. In other words, a sending IHS, namely IHS A, generates or otherwise provides a 9000 byte data packet for transfer or communication through a communication path of network 200 to a receiving IHS, namely IHS C. In order to transfer jumbo packet 210 from IHS A to IHS C, IHS A determines a path for that communication transfer. More specifically, operating system 190 of IHS A determines a jumbo packet 210 communication path, as per block 415. For example, IHS A may determine that the most efficient use of network 200 resources directs a path for IHS A to IHS C as that communication path through switches 1, 2, 3, and 4. In other words, operating system 190 determines the best communication path for jumbo packet 210 transfer from IHS A to IHS C as being a communication path from IHS A to switch 1, switch 1 to switch 2, switch 2 to switch 3, switch 3 to switch 4, and switch 4 to IHS C. IHS A may rely on other software (not shown), such as that of network devices of network 200 to provide information relevant to generating and determining communication path choices.

In the disclosed embodiment, each communication path partner between IHS A and IHS C broadcasts its MTU size, as per block 420. In this manner, IHS A may interpret the data packet size constraints for each path partner or member of the communication path from IHS A to IHS C. To initiate data packet transfer, IHS A transfers jumbo packet 210 to switch 1, as per block 430. Since both IHS A and switch 1 exhibit an MTU of 9000 bytes, jumbo packet 210 may transfer between these communication path partners, namely IHS A and switch 1, intact or as a full jumbo packet.

Switch 1 packet manager 180 fragments jumbo packet 210 into multiple normal packets 220, as per block 440. Because the next or downstream path partner in the communication path for switch 1, namely switch 2 exhibits an MTU of 1500 bytes, packet manager 180 of switch 1 determines that the transfer of jumbo packet 210 requires a reduction or fragmentation in size into multiple normal packets 220 of 1500 bytes or less. In this manner, information of jumbo packet 210 is safe in the form of normal packets 220 during transfer along the communication path. Switch 1 transfers normal packets 220 to switch 2, as per block 450. In other words, switch 1 transfers, sends, or otherwise communicates the information of jumbo packet 210 in the form of multiple normal packets, namely normal packets 220 to switch 2. Switch 2 transfers normal packets 220 to switch 3, as per block 460. Although switch 3 exhibits an MTU size of 9000 bytes, during the transfer from switch 2 to switch 3, packet manager 180 of switch 2 constrains the transfer size to the lowest MTU size of both switch 2 and switch 3, namely 1500 bytes. In this example, because switch 2 exhibits an MTU of 1500 bytes, the transfer from switch 2 includes multiple normal data packet transfers, such as those of normal packets 220.

Switch 3 packet manager 180 reassembles the multiple normal packets of normal packets 220 into jumbo packet 210, as per block 470. Switch packet manager 180 of switch 3 tests to determine if both switch 3 and switch 4 exhiibit the same jumbo packet size. If switch packet manager 180 of switch 3 determines that—switch 4 and switch 3 are capable of communicating using the same large jumbo packet size, then switch 3 reassembles the multiple normal packets that it receives into a jumbo packet In this manner, network 200 provides a reduction in total data packet transfers along the communication path between sending IHS A and receiving IHS C. Switch 3 transfers reassembled jumbo packet 210 to switch 4, as per block 480. Switch 4 packet manager 180 fragments jumbo packet 210 into multiple normal packets, as per block 485. In other words, packet manager 180 of switch 4 reduces jumbo packet 210 by fragmentation into multiple normal packets 220 for transfer to the next downstream path partner of the network 200 communication path, namely IHS C.

Thus, switch 4 transfers normal packets 220 to IHS C, as per block 490. Although data packet transfer resources may continue as long as network 200 is active, for this embodiment, the disclosed packet fragmentation and reassembly methodology ends, as per block 495. In another embodiment of the disclosed packet manager fragmentation and reassembly methodology, packet manager 180 of IHS C may reassemble the normal packets 220 back into jumbo packet 210. IHS may also retain the fragmented jumbo packet 210 in multiple normal packets 220. For example, if IHS C uses jumbo packet 210 information internally, IHS C may require a reassembly. However, IHS C may send the jumbo packet 210 data as normal packets 220 to another device of network 200 (not shown). In that case, IHS C may retain the normal packet size, namely that of normal packets 220 that it receives from switch 4.

As will be appreciated by one skilled in the art, aspects of the disclosed packet management technology may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of communicating information, comprising
generating, by a first information handling system (IHS), a jumbo information packet for transmission to a second IHS via a plurality of network devices in a communication path between the first and second IHSs, the first and second IHSs employing jumbo information packets as a maximum transmission unit (MTU) size thereof, each of the plurality of network devices exhibiting a respective MTU size;
fragmenting, by a first jumbo MTU size network device of the plurality of network devices, the jumbo information packet into multiple normal information packets if the MTU size decreases between the first jumbo MTU size network device and a second network device downstream of the first jumbo MTU size network device in the communication path; and
reassembling, by a third network device downstream of the second network device, the multiple normal information packets into a jumbo information packet if the MTU size of the third downstream network device and a fourth network device downstream of the third network device both accommodate a jumbo information packet, thus providing a reassembled jumbo information packet.

2. The method of claim 1, further comprising:
transmitting, by the third network device, the reassembled jumbo information packet to the fourth network device.

3. The method of claim 2, further comprising:
transmitting, by the fourth network device, the reassembled jumbo information packet to the second IHS.

4. The method of claim 2, further comprising:
fragmenting, by the fourth network device, the reassembled jumbo information packet into multiple information packets and transmitting these multiple information packets to a third IHS as normal information packets.

5. The method of claim 1, wherein the plurality of network devices includes a plurality of switches.

6. The method of claim 1, wherein the plurality of network devices includes a plurality of routers.

7. The method of claim 1, wherein the plurality of network devices includes a plurality of hubs.

8. A communication system, comprising a first information handling system (IHS);
a second IHS coupled to the first IHS by a plurality of network devices that form a communication path between the first IHS and the second IHS;
wherein the first IHS generates a jumbo information packet for transmission to the second IHS via the plurality of network devices in the communication path between the first and second IHSS, the first and second IHSS employing jumbo information packets as a maximum transmission unit (MTU) size thereof, each of the plurality of network devices exhibiting a respective MTU size;
the communication path including a first jumbo MTU size network device that fragments the jumbo information packet into multiple normal information packets if the MTU size decreases between the first jumbo MTU size network device and a second network device downstream of the first jumbo MTU size network device in the communication path; and
the communication path further including a third network device downstream of the second network device that reassembles the multiple normal information packets into a jumbo information packet if the MTU size of the third downstream network device and a fourth network device downstream of the third network device both accommodate a jumbo information packet, thus providing a reassembled jumbo information packet.

9. The communication system of claim 8, wherein the third network device transmits the reassembled jumbo information packet to the fourth network device.

10. The communication system of claim 9, wherein the fourth network device transmits the reassembled jumbo information packed to the second IHS.

11. The communication system of claim 9, wherein the fourth network device fragments the reassembled jumbo information packet into multiple normal information packets and transmits these multiple information packets to a third IHS.

12. The communication system of claim 8, wherein the plurality of network devices includes a plurality of switches.

13. The communication system of claim 8, wherein the plurality of network devices includes a plurality of routers.

14. The communication system of claim 8, wherein the plurality of network devices includes a plurality of hubs.

15. A computer program product, comprising:
a computer readable storage medium for use on a first information handling system (IHS), a second IHS and a plurality of network devices that form a communication path between the first IHS and the second IHS;
first instructions that generate a jumbo information packet for transmission to the second IHS via the plurality of network devices in the communication path between the first and second IHSS, the first and second IHSS employing jumbo information packets as a maximum transmission unit (MTU) size thereof, each of the plurality of network devices exhibiting a respective MTU size;
second instructions that instruct a first jumbo MTU size network device in the communication path to fragment the jumbo information packet into multiple normal information packets if the MTU size decreases between the first jumbo MTU size network device and a second network device downstream of the first jumbo MTU size network device in the communication path; and
third instructions that instruct a third network device downstream of the second network device in the communication path to reassemble the multiple normal information packets into a jumbo information packet if the MTU size of the third downstream network device and a fourth network device downstream of the third network device both accommodate a jumbo information packet, thus providing a reassembled jumbo information packet;
wherein the first, second and third instructions are stored on the computer readable storage medium.

16. The computer program product of claim 15, further comprising fourth instructions that instruct a third network device to transmit the reassembled jumbo information packet to the fourth network device.

17. The computer program product of claim 16, further comprising fifth instructions that instruct the fourth network device to transmit the reassembled jumbo information packet to the second IHS.

18. The computer program product of claim 16, further comprising sixth instructions that instruct the fourth downstream network device to fragment the reassembled jumbo information packet into multiple information packets and transmit these multiple information packets to a third IHS as normal information packets.

19. The computer program product of claim 15, wherein the plurality of network devices includes a plurality of switches.

20. The computer program product of claim 15, wherein the plurality of network devices includes a plurality of routers.
